(19) United States
(12) Patent Application Publication
(10) Pub. No.: US 2011/0171901 A1
(43) Pub. Date: Jul. 14, 2011

(54) MULTIPLE FEED ANTENNA AND METHODS OF USING SAME

(76) Inventor: Gregory Thane Wyler, Stuart, FL (US)

(21) Appl. No.: 12/761,940

(22) Filed: Apr. 16, 2010

Related U.S. Application Data
(63) Continuation of application No. PCT/US2008/080454, filed on Oct. 20, 2008.
Application No. PCT/US2008/080454 is a continuation-in-part of application No. PCT/US2007/081763, filed on Oct. 18, 2007.
Application No. PCT/US2007/081763 is a continuation-in-part of application No. PCT/US2008/075372, filed on Sep. 5, 2008.

(51) Int. Cl. H04B 7/185; H01Q 3/24; H04B 17/02

(52) U.S. Cl. 455/9; 343/876; 455/12.1

(57) ABSTRACT

An antenna and method of using the antenna is disclosed, that may include a feed assembly including a plurality of feed horns disposed at a plurality of different respective angles within the antenna; a detection system for tracking a movement of a satellite through a tracking range of the antenna; and a switch for transferring a communication path through a succession of the feed horns based on data obtained by the detection system.

### CROSS-REFERENCE TO RELATED APPLICATIONS

This application is a Continuation of PCT application Serial No. PCT/US08/80454, filed Oct. 20, 2008, entitled “MULTIPLE FEED ANTENNA AND METHODS OF USING SAME” [Attorney Docket 790-6-PCT], published as Pub. No. WO 2009/052477 on Apr. 23, 2009; and this application is a Continuation-In-Part Application of PCT Application Serial Number PCT/US07/81763, filed Oct. 18, 2007, entitled “SYSTEM AND METHOD FOR SATELLITE COMMUNICATION” [Attorney Docket 790-2-PCT], published as Pub. No. WO 2009/051592 on Apr. 23, 2009; and is also a Continuation-In-Part Application of PCT Application Serial Number PCT/US08/75372, filed Sep. 5, 2008, entitled “APPARATUS AND METHODS FOR SATELLITE COMMUNICATION” [Attorney Docket 790-5-PCT], published as Pub. No. WO 2009/051907 on Apr. 23, 2009, all of which applications are hereby incorporated by reference herein in their entirety.

### BACKGROUND OF THE INVENTION

The present invention relates in general to communication systems and in particular to systems and methods for satellite communication.

Satellite communication systems provide various benefits to consumers of communication services such as for telephony, internet communications, television communications among others. Benefiting from the availability of satellites requires having earth-based equipment configured to communicate with satellites of various types. Various satellite systems are currently available, which employ a variety of orbits. Accordingly, the earth-based equipment for communicating with satellites varies in accordance with the type of orbit employed by a particular satellite system.

Satellites in Geo-stationary Orbits (GSO) remain fixed with the respect to a given sub-satellite point on the earth. Thus, earth-based equipment configured for communication with GSO satellites may remain in communication with GSO satellites using earth-based antennas having fixed orientations with respect to the surface of the earth and with respect to the ground station they are mounted on.

However, various applications benefit from the lower latency periods afforded by satellites in Non-Geostationary Orbits (NGSOs) such as medium earth orbits (MEOs—between about 2,000 kilometers (km) and 36,000 km) and low earth orbits (LEOs—below 2000 km). Existing LEO and MEO satellite systems employ inclined orbits to enable such systems to reach high concentrations of customers located in the northern and southern hemispheres. In such orbits, the satellites move continuously with respect to various earth stations, and associated antennas, with which they communicate. Moreover, successive satellites in such constellations commonly move along different orbits. Thus, many such systems employ omni-directional antennas at earth-based user terminals to enable ongoing communication to take place as the various satellites in a constellation move through their respective orbits. However, such omni-directional antennas have very low gain, thereby limiting the communication throughput (communication bandwidth) achievable using this approach. One way to compensate for the low gain level of the antennas at the user terminal is to significantly increase the power used for satellite antenna transmission. However, such increased satellite transmission power levels increase the cost of operating the antenna.

In other cases, earth stations in communication with satellites in LEO or MEO orbits may employ mechanical tracking or phased array (electronically steerable) antennas for communication with the earth-based based user terminals to communicate therewith. Such antennas are very expensive, thereby imposing a significant premium on the cost of communication services employing LEO/MEO satellite systems. Accordingly, there is a need in the art for earth-based antenna systems capable of communicating with satellites in non-geostationary orbits that are available at a reasonable cost.

### SUMMARY OF THE INVENTION

According to one aspect, the invention is directed to a method, that may include arranging a plurality of feed horns along a plurality of different respective angles about a common axis within an antenna; and switching a communication path through the antenna through a succession of the feed horns. Preferably, the switching step includes transferring substantially an entirety of the RF (radio frequency) energy in the antenna through successive ones of the feed horns. Preferably, the method further includes directing substantially all of the RF energy of the antenna through one feed horn at a time. Preferably, each feed horn is operable, in cooperation with at least one reflector, to direct a spot beam to a satellite. Preferably, each feed horn is configured to be able to individually handle all of the communication RF energy for the antenna.

According to one aspect, the invention is directed to an antenna that may include a feed assembly including a plurality of feed horns disposed at a plurality of different respective angles within the antenna; a detection system for tracking a movement of a satellite through a tracking range of the antenna; and a switch for transferring a communication path through a succession of the feed horns based on data obtained by the detection system. Preferably, the antenna further includes a sub-reflector operable to receive RF energy from the feed assembly; and a main reflector for directing RF energy from the sub-reflector toward the satellite. Preferably, the plurality of feed horns is operable to produce a plurality of respective communication beams oriented at a plurality of different respective topocentric beam angles. Preferably, the plurality of feed horns are arranged in a row within a single plane within the feed assembly. Preferably, the feed assembly is pivotable to adjust for changes in an elevation angle of the satellite as the satellite moves along its orbit.

According to another aspect, the invention is directed to a method for maintaining a communication path between an earth-based antenna and a satellite moving along an orbit, comprising: providing a feed assembly having a plurality of feed horns oriented along a plurality of different respective angles; determining a location along the orbit at which the satellite is located; and activating a selected one of the feed horns that is operable to generate an RF (radio frequency) signal communication beam that enables communication between the antenna and the satellite. Preferably, the method further includes not providing enough RF signal energy to enable a communication beam to feed horns other than the selected feed horn. Preferably, the method further includes shifting the communication path between the antenna and the satellite through a succession of the feed horns as the satellite proceeds along the orbit.

Preferably, the determining step includes measuring a level of RF signal energy received at the antenna; and comparing the measured RF signal power level to a threshold indicative of signal power sufficiency for communication. Preferably, the method further includes enabling the plurality of feed horns to generate a plurality of respective communication beams a plurality of different respective beam angles. Preferably, the plurality of respective generated beam angles are configured to enable communication between the satellite and the antenna at a plurality of respective stages of advancement of the satellite along the orbit. Preferably, the step of shifting the communication path includes: supplying RF signal energy to a selected feed horn in communication with the satellite at any given moment; and at least substantially disabling a supply of RF signal energy to all feed horns in the feed assembly other than the selected beam. Preferably, the steps of supplying and at least substantially disabling are performed using at least one switch. Preferably, the method further includes pivoting the feed assembly to adjust for changes in an elevation angle of the satellite as the satellite proceeds along the orbit.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram of a communication system including earth-based communication systems in accordance with an embodiment of the present invention;

FIG. 2 is a schematic block diagram of an antenna at an earth station in communication with a given satellite at various points along the orbit of the satellite, in accordance with an embodiment of the present invention;

FIG. 2A shows a communication path between an earth based antenna and a satellite based antenna at leading communication range boundary, in accordance with an embodiment of the present invention;

FIG. 2B shows a communication path between an earth based antenna and a satellite based antenna at a center of a communication range of the present invention in accordance with an embodiment of the present invention;

FIG. 2C shows a communication path between an earth-based antenna and a satellite-based antenna at leading communication range boundary, in accordance with an embodiment of the present invention;

FIG. 3 is a block diagram of an antenna communication control system in accordance with an embodiment of the present invention;

FIG. 4 is a perspective view of an antenna in accordance with an embodiment of the present invention;

FIG. 5 is a perspective view of the antenna of FIG. 4 in accordance with an embodiment of the present invention;

FIG. 6 is a planar view of the feed assembly of the antenna of FIG. 4 in accordance with an embodiment of the present invention;

FIG. 7 is a partially perspective and partially plan view of the antenna of FIG. 4, showing beam reflection patterns, in accordance with an embodiment of the present invention;

FIG. 8 is a schematic diagram of a satellite antenna in communication with an antenna at a ground station, in accordance with an embodiment of the present invention;

FIG. 9 is a schematic diagram of the system of FIG. 8 in which the satellite has advanced along its orbit;

FIG. 10 is a schematic diagram of the system of FIG. 8 in which the satellite has advanced still further along its orbit;

FIG. 11 is a schematic diagram of the system of FIGS. 8-10 in which the antenna at the earth station is in communication with a second satellite, in accordance with an embodiment of the present invention;

FIG. 12 is a schematic diagram of a satellite having a plurality of mechanically steerable antennas in accordance with an embodiment of the present invention;

FIG. 13 is a schematic diagram of a satellite having a plurality of electronically steerable antennas in accordance with an embodiment of the present invention; and

FIG. 14 is a block diagram of a computer system adaptable for use with an embodiment of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” or “in an embodiment” in various places in the specification do not necessarily all refer to the same embodiment.

Those skilled in the art will appreciate the fact that antennas, which may include beamformers, and/or may include equipment for communicating over optical links which communicate either with other satellites or with ground stations (which may also be referred to as earth stations), are reciprocal transducers which exhibit similar properties in both transmission and reception modes. For example, the antenna patterns for both transmission and reception are generally identical and may exhibit approximately the same gain. For convenience of explanation, descriptions are often made in terms of either transmission or reception of signals, on the understanding that the pertinent description applies to the other of the two possible operations. Thus, it is to be understood that the antennas of the different embodiments described herein may pertain to either a transmission or reception mode of operation. Those of skill in the art will also appreciate the fact that the frequencies received and/or transmitted may be varied up or down in accordance with the intended application of the system.

One or more embodiments of the present invention address the limitations of existing systems by providing apparatus and methods for quasi-tracking a satellite moving through the satellite tracking range of a given earth-station based antenna. The afore-mentioned “satellite tracking range” of a given earth station preferably corresponds to the “earth-station communication orbit segment” of a given satellite. In an embodiment, “quasi-tracking” as practiced herein preferably corresponds to changing the communication direction of an antenna in discrete steps by shifting the communication path through a succession of beamformers oriented at a succession of different respective angles, instead of changing the communication beam orientation continuously.

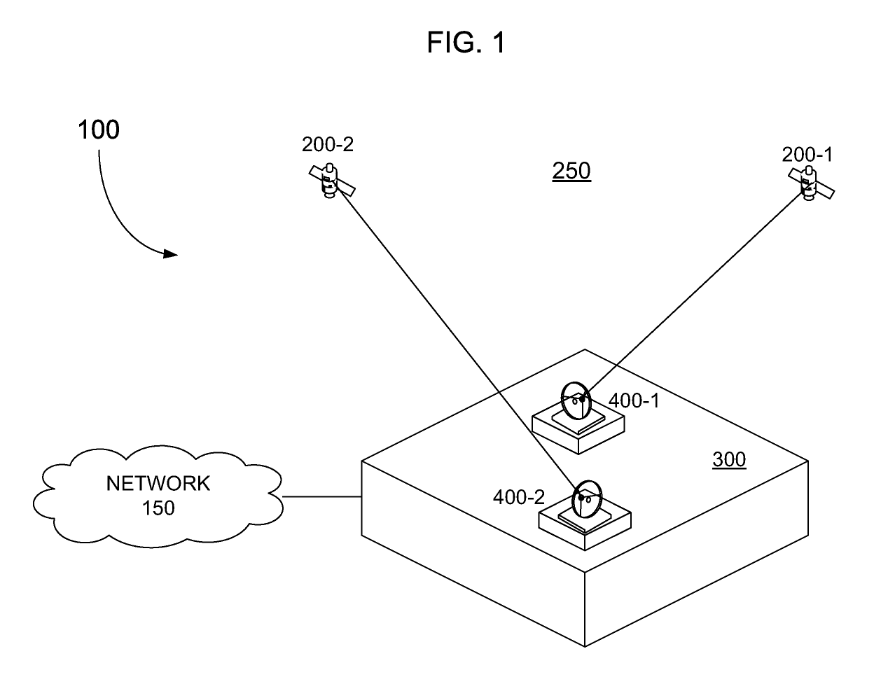

FIG. 1 is a block diagram of a communication system 100 including earth-based communication systems 150, 300 in accordance with an embodiment of the present invention. In an embodiment, network 100 may include communication network 150, earth station 300, and satellite constellation 250. Earth station may include antennas 400-1 and/or 400-2. Communication network 150 is preferably a terrestrial communication network that is operable to connect earth station 300 to one or more communication networks, such as the Internet, one or more telephone networks, cable television networks, and/or any other desired communication systems. Communication network 150 may include wired and/or wireless communication links.

Satellite constellation 250 is a grouping of satellites 200-1, 200-2 etc. (collectively “200”) that may travel in a predetermined orbit around the earth. In an embodiment the satellites 200 in constellation 150 may travel in a substantially equatorial MEO orbit, at an altitude of about 2,000 km and 20,000 km. More specifically, satellites 200 may travel in an orbit at an altitude between about 5,000 km and about 15,000 km. In one embodiment, satellites 200 may travel in an orbit at an altitude between about 7,000 km and about 9,000 km. Constellation 250 may include eight satellites, sixteen satellites, or any desired number of satellites 200. In other embodiments, constellation 250 could include fewer than or more than sixteen satellites.

In system 100, antennas 400-1 and 400-2 may operate in a round-robin manner to ensure to ensure continuity of communication between satellite constellation 250 and earth station 300. Specifically, antenna 400-1 may communicate with satellite 200-1 proceeds along its orbit (to the right, in the view of FIG. 1). As satellite 200-1 reaches the end of the orbit segment over which earth station 300 communicates with satellites 200 within constellation 250, satellite 200-2 may enter the pertinent orbit segment and begin communicating with satellite 400-2. Antennas 400-1 and 400-2 may continue to communicate with alternating ones of the satellites 200 in constellation 250 to ensure that continuity of communication is maintained.

However, in other embodiments, a single antenna 400-1 could ensure that the continuity of communication between earth station 300 and satellite constellation 250 is maintained. This may be achieved by employing a multiple-feed antenna (also referred to herein as “multi-feed antennas”) in accordance with an embodiment of the present invention. The operation and structure of such multi-feed antennas are discussed in greater detail below.

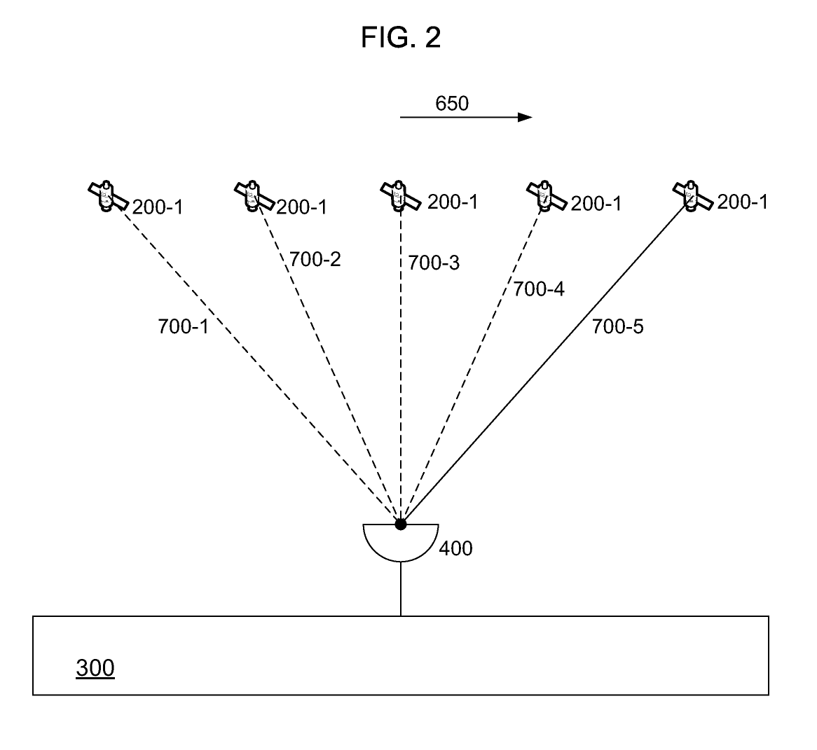

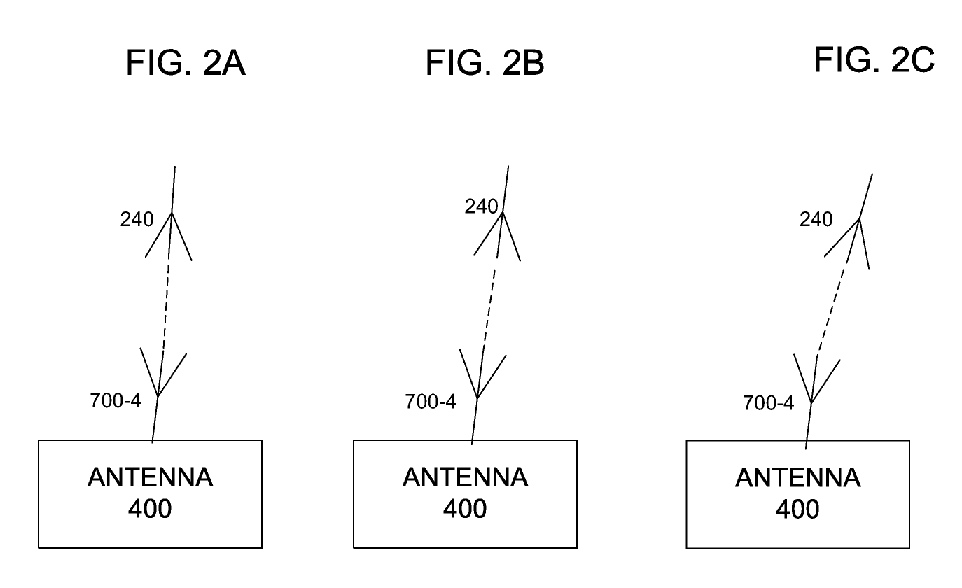

FIG. 2 is a schematic block diagram of an antenna 400 at an earth station 300 in communication with a satellite 200-1 at various points along the orbit 650 of the satellite, in accordance with an embodiment of the present invention. FIG. 2 shows satellite 200-1 at five separate locations along its travel along orbit 650. The five satellite 200-1 locations are intended to illustrate points at which an antenna on the satellite is in centroid to centroid alignment with five respective spot beams emanating from antenna 400 on earth station 300. The five spot beams 700-1-700-5 are preferably generated by five respective antenna feeds (also referred to herein as “feed horns”) disposed at five separate orientations. For the sake of simplicity of illustration, the five separate feeds employed to generate beams 700-1, 700-2, 700-3, 700-4, and 700-5 are not shown in FIG. 2.

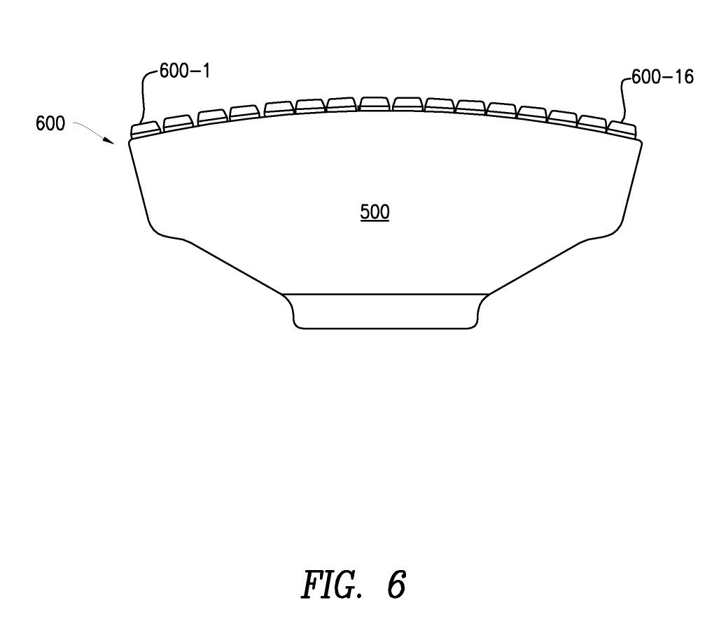

FIG. 2 shows the center-lines of five beams 700-1, 700-2, 700-3, 700-4, and 700-5 that are preferably provided by five separate respective feeds (feeds not shown in FIG. 2). In this embodiment, each feed preferably produces a separate beam. Later in this disclosure, FIG. 6 shows a different embodiment including sixteen feeds, that produce sixteen respective beams, and showing antenna 400 in greater detail. However, returning to FIG. 2, as satellite 200-1 moves along orbit 650, the data communication path between satellite 200-1 and antenna 400 is transferred, at appropriate times, through a succession of beams 700, from beam 700-1 through beam 700-5, and by extension, through a corresponding succession of separate antenna feeds that produce beams 700-1 through 700-5. In this manner, antenna 400 effectively “quasi-tracks” the motion of satellite 200-1 along orbit 650 by successively transferring the data communication path between satellite 200-1 and earth station 300 through a succession of antenna feeds within antenna 400, rather than by changing the physical orientation of antenna 400 to track the motion of satellite 200-1.

FIG. 2 is intended to illustrate the presence of five separate beams emerging from five respective feeds (feeds not shown for the sake of simplicity). Later in this document, the details of one embodiment of antenna 400 which include sixteen separate feeds are shown in greater detail. However, the principles of operation of the embodiment of FIG. 2 and the embodiment of FIG. 16 are similar. It will be appreciated that the present invention is not limited to employing any particular number of feeds or associated beams. Fewer or more than five feeds may be included in antenna 400.

This section discusses terminology pertinent to the alignment of antenna(s) on satellites 200 and one or more antennas 400 on earth station 300. Herein, each antenna feed within antenna 400 is able to produce its own spot beam for transmitting/receiving data to/from satellite 200-1. Each such spot beam preferably has a distribution of signal intensity for communication with a target (such as with an antenna on a satellite) that reaches a maximum at centroid-to-centroid alignment (that is, where the beams are perfectly aligned). Generally, the signal intensity for such a beam declines with increasing misalignment of the beams. For the schematically displayed arrangement of FIG. 2 to operate properly, a lower-limit threshold (such as least one half of maximum signal power) of signal intensity should be established for a communication beam, below which the communication path between satellite 200-1 and antenna 400 is transferred from a currently active feed to another feed on antenna 400. The communication path between antenna 400 and satellite 200-1 is intended to be switched through a succession of feeds on antenna 400 as satellite 200-1 moves along the pertinent segment of its orbit 650 in proximity to earth station 300. In this embodiment, the signal power of the beam forming the communication path between satellite 200-1 and earth station 300 (thus, through antenna 400) is preferably maintained in between maximum signal power and one half of maximum signal power (sometimes referred to as the 3 dB (decibel) level). However, in alternative embodiments, lower-limit signal power thresholds other than one half of maximum power may be employed.

The range over which each feed (also referred to herein as “feed horn” or “beamformer”) of antenna 400 communicates with satellite 200-1 is a communication alignment range, or merely “communication range”. This communication alignment range preferably includes a center (at which maximum signal communication power prevails), a leading communication alignment boundary (at which communication with the given feed preferably begins), and a trailing communication alignment boundary (at which communication with the given feed preferably terminates). The communication alignment range, and the center and boundaries thereof, may be expressed in several ways, including as a segment of the orbit 650, the angular range that the antenna on the satellite moves through while within the communication alignment range, and/or as the angular magnitude of the communication range as measured from the vantage point of antenna 400 on earth station 300. These concepts are explained further with reference to FIGS. 2A, 2B, and 2C.

FIGS. 2A, 2B, and 2C show the positioning and orientation of satellite antenna 240 on satellite 200-1 (not shown) with respect to a single beam 700-4 of antenna 400 at various stages of advancement (from left to right in the view of FIGS. 2A, 2B, and 2C) of satellite 200-1 (now shown) along its orbit 650. Y-shaped drawing feature 250 is intended to correspond to the orientation of an antenna mounted on satellite 200-1. Y-shaped drawing feature 700-4 is intended to illustrate the orientation of an antenna beam and not necessarily the physical structure of antenna 400 or any mechanical component thereof. For the discussion of FIGS. 2A through 2C, beam 700-4 is preferably employed as the communication data path between antenna 240 of satellite 200-1 and antenna 400 of earth station 300. Beam 700-4 preferably extends between antenna 240 and a single antenna feed of antenna 400.

In FIG. 2A, antenna 240 of satellite 200-1 has just reached the leading (left-most in the view of FIGS. 2A-2C) communication alignment boundary. In the situation shown in FIG. 2A, the signal power of the beam between antenna 240 and antenna 400 may be at about one half of maximum signal power. Antenna 240 of satellite 200-1 then proceeds to the location relative to antenna 400 shown in FIG. 2B. FIG. 2B shows antenna 240 and beam 700-4 in centroid-to-centroid alignment (which may also be referred to as “centroid alignment”). With the relative orientation and positioning shown in FIG. 2B, the signal strength of the communication beam, and more specifically, the signal power detected at earth station 300, is preferably at the maximum level. As satellite 200-1 and antenna 240 which is located thereon proceed further along orbit 650, the situation shown in FIG. 2C is reached. FIG. 2C shows antenna 240 at the trailing boundary of the communication alignment range. With the relative positioning shown in FIG. 2C, the signal power detected at earth station 300 may be at about one half of full power. As satellite 200-1 and its antenna 240 proceed further along orbit 650, antenna 240 will ultimately establish communication with earth station 300 using another feed within antenna 400.

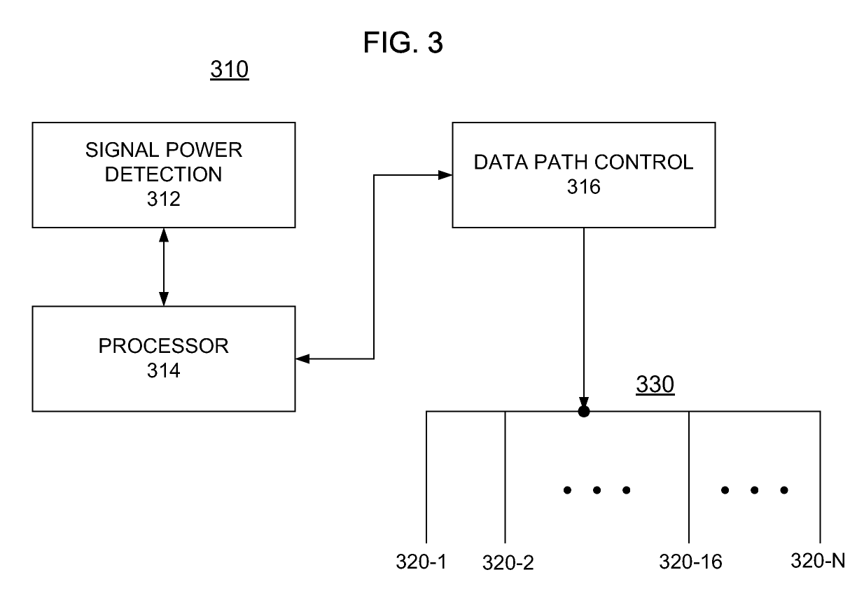

FIG. 3 is a block diagram of antenna communication control system 310 in accordance with an embodiment of the present invention. Control system 310 may include signal power detection equipment 312, processor 314, data path control 316, and/or waveguide grouping 320. Each waveguide 320-n preferably connects to a respective antenna feed 600-n (FIG. 6). Communication control system 310 is preferably operable to select one waveguide 320, among the available waveguides, to activate based on data obtained by signal power detection equipment 312. For the sake of simplicity, only a selection of waveguides 320-1 through 320-16 are schematically illustrated. Further, waveguide 320-N is shown to indicate that the present invention is not limited to employing sixteen waveguides and sixteen corresponding antenna feeds.

Signal power detection equipment 312 is preferably operable to detect the strength of the signal power of a communication beam between an antenna 400 on earth station 300 and a satellite 200.

Processor 314 may be any conventional digital computing device (or alternatively a suitably configured analog device) suitable for receiving data from signal power detection equipment 312 and transmitting data and/or control information to data path control equipment 316. In alternative embodiments, processor 314 could be omitted.

Data path control 316 is preferably operable to receive information describing a current signal reception power level and select a waveguide 320-x in accordance with the received signal power information. In a preferred embodiment, data path control 316 selects just one waveguide 320 and therefore just one antenna feed 600 along which to transmit RF (Radio Frequency) signal energy. However, in alternative embodiments, data path control 316 may be operable to transmit RF communication signal energy along two or more waveguides 320 and thus along the respective antenna feeds 600 coupled to the two or more waveguides.

In an embodiment, as satellite 200-1 (FIG. 2) travels along orbit 650 and travels through a succession of communication alignment ranges corresponding to a succession of respective antenna feeds, control system 310 is preferably operable to transfer the data communication path between earth station 300 and satellite 200-1 through a succession of waveguides 320 until the satellite 200-1 leaves the communication range of antenna 400 as a whole.

An example is presented herein to illustrate the operation of the antenna control system 310 of FIG. 3. We adopt an initial condition in which the data transmission path between antenna 400 and satellite 200-1 is being directed through waveguide 320-1 and feed 600-1 (not shown in FIG. 3). Signal detection equipment 312 preferably monitors the signal power received at feed 600-1 of antenna 400 and then conveyed to waveguide 320-1. The signal power received preferably starts at about one half of full power (at the leading communication alignment range boundary), then increases to full power when beam 700-1 from feed 600-1 is ideally aligned (centroid alignment) with antenna 240 of satellite 200-1. Thereafter, the received signal power detected at antenna 400 will likely decline. In this embodiment, once the received signal power declines to one half of full signal power, signal power detection equipment 312 preferably indicates this condition to processor 314 and/or data path control 316. Thereafter, data path control 316 preferably operates to activate waveguide 320-2 and de-activate waveguide 320-1, thereby transferring the data communication path between satellite 200-1 and earth station 300 from the combination of waveguide 320-1 and feed 600-1, to waveguide 320-2 and feed 600-2.

The above-described process may be repeated for waveguides 320-2 through 320-16 as satellite 200-1 proceeds along the segment of orbit 650 in proximity to earth station 300, thereby enabling antenna 400 to quasi-track satellite 200-1 for a portion of orbit 650 without requiring any moving parts, and while conducting high-bandwidth communication with satellite 200-1 using a succession of concentrated spot beams.

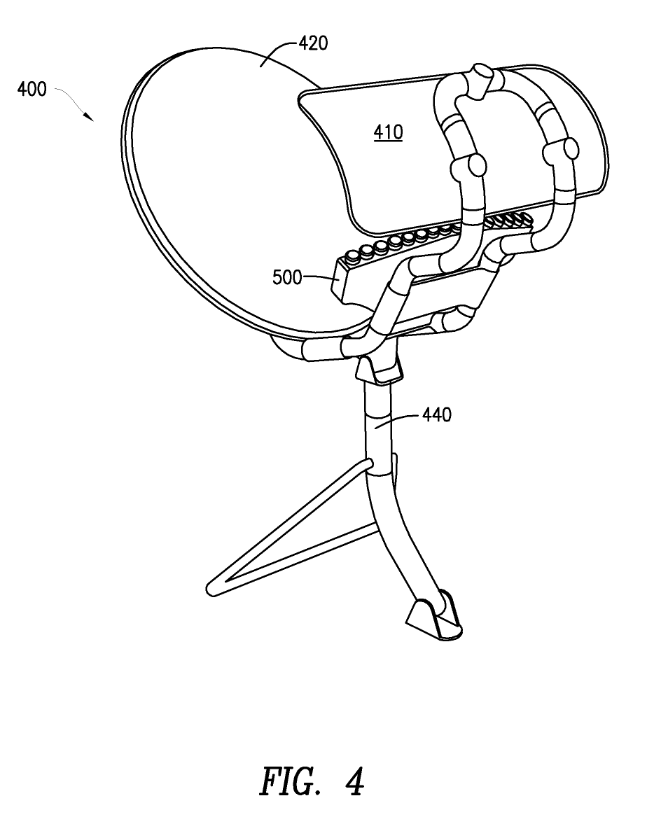

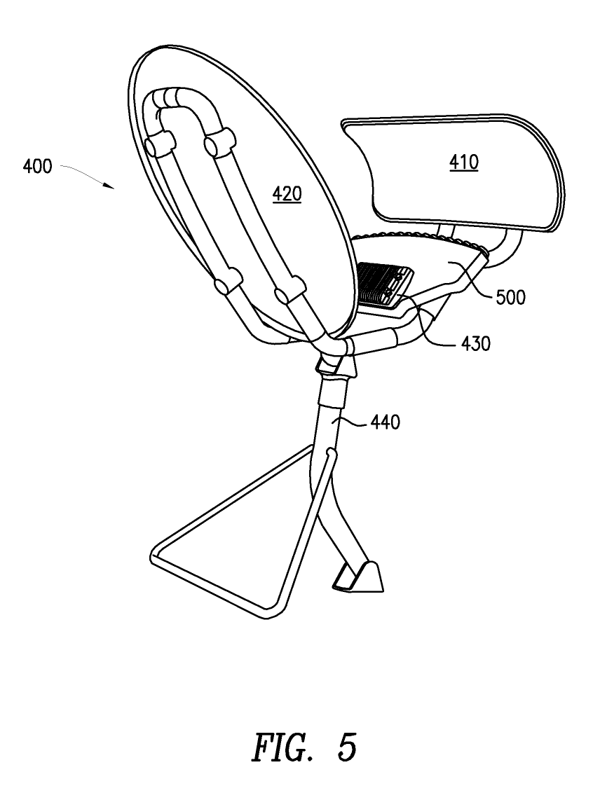

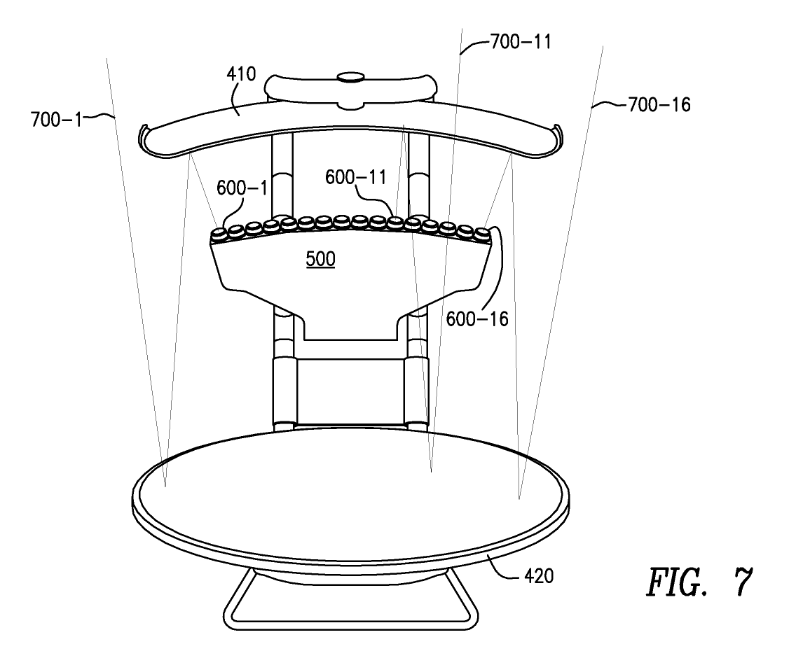

FIG. 4 is a perspective view of an antenna 400 in accordance with an embodiment of the present invention. FIG. 5 is another perspective view of the antenna of FIG. 4. FIG. 6 is a planar view of the feed assembly 500 of the antenna of FIG. 4 in accordance with an embodiment of the present invention. FIG. 7 is a partially perspective and partially plan view of antenna 400, showing beam reflection patterns, in accordance with an embodiment of the present invention. Antenna 400 may include stand 440, feed assembly 500, antenna feeds (beamformers) 600, sub-reflector 410, main reflector 420, and electrical box 430.

Stand 440 is believed to be self-explanatory and is therefore not described in detail herein. In this embodiment, reflector 410 is a sub-reflector disposed between feeds 600 and main reflector 420. Sub-reflector 410 may be concave shaped, when viewed from above, as shown in FIG. 7. However, in other embodiments, sub-reflector 410 could be convex-shaped in the view of FIG. 7, or may provided in any other shape needed to suitably configure beams 700.

Main reflector 420 is an antenna reflector operable to reflect RF signal energy from sub-reflector 410 and direct the reflected energy toward a target device with which antenna 400 is communicating. The reverse direction of energy transmission is also in effect of course. Specifically, RF signal energy received from a target device may be received at main reflector 420, reflected toward sub-reflector 410, and in turn directed toward one or more feeds 600.

Electrical box 430 (FIGS. 5 and 7) may be operable to provide power for feed assembly 500 and/or to provide part or all of the functionality of control system 310 illustrated in FIG. 3. Feed assembly 500 preferably includes feeds 600 and a housing within which feeds 600 are housed. Feeds 600 may be conventional antenna feeds, but are not limited to this implementation. Feeds 600 may have positions and orientations that are fixed with respect to antenna 400 and earth station 300. However, in other embodiments, individual feeds 600 and/or feed assembly may be mobile linearly and/or angularly with respect to the remainder of antenna 400. In a preferred embodiment, antenna 400 may be fixed with respect to earth station 300. However, in one or more alternative embodiments, antenna 400 may be mobile, linearly and/or angularly, with respect to earth station 300. In the embodiments shown in FIGS. 4-7, sixteen feeds, feeds 600-1 through 600-16, are shown. However, in alternative embodiments, fewer or more than sixteen feeds may be employed with antenna 400.

Antenna 400 of FIGS. 4-5 is preferably operable to provide a plurality of beams 700 having a geometric arrangement similar to that shown in FIG. 2. Specifically, the feeds 600 within feed assembly 500 are preferably arranged such that the beams 700 formed, upon reflecting RF energy emerging from the respective feeds 600 off sub-reflector 410 and then off main reflector 420, resemble the distribution of beams 700 shown in FIG. 2.

FIGS. 4-5 show one possible implementation of an earth-based, multiple-feed antenna 400 for quasi-tracking a satellite 200-1. FIGS. 4-5 show a dual reflector embodiment of antenna 400. However, the present invention is not limited to the use of a dual-reflector embodiment. In the following, the geometric arrangement of feeds 600-n and of the beams 700-n generated by the respective feeds 600-n are described in greater detail.

FIG. 6 is a planar view of the feed assembly 600 of the antenna of FIG. 4 in accordance with an embodiment of the present invention. FIG. 7 is a partially perspective and partially plan view of the antenna of FIG. 4, showing beam reflection patterns, in accordance with an embodiment of the present invention.

The embodiment of FIG. 6 shows feed assembly 500 which may include feeds 600-1 through 600-16 (collectively 600). References numeral 600-2 through 600-14 have been omitted from FIG. 6 for the sake of convenience and simplicity of illustration. In this embodiment, the orientation of the feeds 600 varies continuously from feed 600-1 to 600-16. In this embodiment, the longitudinal dimension of feeds 600 are preferably all aligned within a single plane within feed assembly 500, as shown in FIG. 5. Thus, in this embodiment, the axis about which the orientation of the feeds 600 varies is preferably located at a point substantially below the displayed structure of feed assembly 500, and preferably runs into and out of the page in the view of FIG. 6. The variation in the orientation of the feeds 600 shown in FIG. 6 represents one way to implement a desired range of resulting beam 700 orientations. However, the present invention is not limited to the direction of feed 600 orientation variation shown in FIG. 6.

The beams 700 resulting from a selection of respective feeds 600 are shown in FIG. 7. Specifically, beams 700-1, 700-11, and 700-16 are shown emanating from feeds 600-1, 600-11, and 600-16, respectively. Illustration of beams from the other feeds 600 is omitted for the sake of simplicity. However, it may be seen that the range of orientations of the beams 700, arising from feeds 600, closely resembles the plurality of beams 700 illustrated in FIG. 2. In a preferred embodiment, the range of angles of beams 700-1 through 700-16 is configured to provide complete coverage of the segment of orbit 650 that satellite 200-1 (FIG. 2) travels through will in proximity to earth station 300. Preferably, as satellite 200-1 reaches the limit (at the right, in the view of FIG. 7) of the communication range of beam 700-16 (which is produced by feed 600-16), satellite 200-1 may begin communication with another antenna that is situated and oriented suitably for communication with satellite 200-1.

Where satellites 200 in constellation 250 (FIG. 1) orbit the earth in an equatorial, or substantially equatorial orbit 650, the variation in the orientation of the beams 700 is operable to adjust mostly or completely for changes in the latitude angle of each satellite 200 as each satellite 200 moves along orbit 650. This discussion addresses a distribution of feed angles and beam angles over given angular ranges. In most embodiments, each individual feed is fixed and does not experience variation in orientation. The variation referred to in this discussion corresponds to a range of feed orientations for a plurality of fixed antenna feeds.

The use of an equatorial orbit tends to simplify the needed distribution of beam 700 angles and the corresponding variation in the orientation of the respective feeds 600. For example, with reference to FIG. 2, where satellite 200-1 follows a completely equatorial orbit 650, the distribution of topocentric angles of beams 700-1 through 700-5 may be arranged in accordance with a variation in latitude angles of satellite 200-1 as satellite 200-1 progresses along its orbit 650. This is the case, because, where satellite 200-1 follows a completely equatorial orbit, satellite 200-1, by definition, always remains at 0 degrees longitude.

The distribution of orientations of the feeds 600 may be arranged to provide the needed variation in beam 700 angles. Since, in some embodiments, the RF energy emerging from feeds 600 is reflected twice before leaving antenna 400 as a beam 700, it will be appreciated that the respective feed 600 angles do not necessarily correspond to the angles of beams 700. Moreover, the relation between the feed 600 angles and beam 700 angles may differ depending on the construction of antenna 400, including such factors as the number of reflectors, the focal lengths of the reflectors, the distance between the reflectors, the shapes of the reflectors, among other factors. However, in some embodiments, each feed 600 is operable to provide one corresponding beam 700. Moreover, once the construction of a given antenna 400 is established, a given feed 600 will preferably always provide a corresponding beam at a given orientation with respect to earth station 300.

In some embodiments, the arrangement of feed 600 orientations shown in FIG. 6 is operable to generate respective beams 700 from antenna 400 suitable for quasi-tracking satellites 200 along a segment of orbit 650 in proximity to earth station 300. However, in other embodiments in which (a) the satellite orbit is not purely equatorial and thus includes an inclination angle of some magnitude and/or (b) where the earth station is located at some distance from the equator, the distribution of feed 600 orientations may be more complicated than that shown in FIG. 6. However, once the latitude at which earth station 300 is located, and the inclination angle of orbit 650 are known, the needed feed 600 orientation angles may be determined. Thereafter, the practice of arranging a plurality of antenna feeds in specified positions and orientations and activating a succession of the feeds 600 as a satellite 200 moves through a segment of its orbit 650 may be readily practiced.

In an alternative embodiment, instead of being fixed in all dimensions with respect to the body of earth station 300 and antenna 400, feed assembly 500 (FIG. 6) could be made pivotable about an axis that runs from left to right in the view of FIG. 6. The ability to pivot feed assembly 500 about one or more other axes in addition to, or instead of, the left-to-right axis described above, could also be implemented. In this manner, feed assembly 500 could pivoted to adjust for a variation in an elevation angle needed for tracking a satellite 200, where earth station 300 is located a substantial distance away from the equator. Alternatively or additionally, in this alternative embodiment, feed assembly 500 could be pivoted to track a satellite following an orbit having a moderate inclination angle. In the foregoing examples involving pivotable feed assemblies 500, the activation of a succession of feeds would still preferably be employed to track the forward movement of a satellite 200 along its orbit 650.

In still other alternative embodiments, an antenna 400 could include a plurality of feed assemblies 500 to enable antenna 400 to communicate with satellites located over a greater range of latitude and longitude. In one embodiment, multiple feed assemblies 500 could be disposed in parallel to enable feeds within different feed assemblies to be used based on the suitability of the elevation angle of the feed in relation to the orbit of a particular satellite. In other embodiments, multiple feed assemblies 500 could be provided in series to provide a greater range of coverage of latitudinal angular range of satellites in communication with earth station 300.

A distinction between one or more embodiments of the present invention and phased array antennas is relevant to the disclosure herein. Phased array antennas commonly employ a plurality of identically oriented antenna elements to generate a single beam. More specifically, with phased array antennas, a single communication beam of a desired magnitude and direction is formed from the vector sum of the contributions of a large number of individual antenna elements. The direction and strength of the resulting beam may be controlled, and altered by controlling the RF transmission energy provided to each of the many antenna elements using a suitable computer control system. The resulting beam is generally broadcast over a wide area and uses a considerable amount of power.

In contrast, in one or more embodiments of the present invention, each feed 600 produces its own beam 700, and each such beam is preferably stationary once established. As discussed above, each beam 700 can service a satellite 200 along a limited portion of the orbit 650 of the satellite 200. Thus, the antenna feeds 600 are preferably oriented so as to provide a sequence of beams 700 that are sufficiently closely angularly spaced to allow a satellite 200 to travel along a segment of its orbit 650 associated with an earth station 300 while maintaining communication continuity with the earth station 300 throughout the travel along the pertinent orbit 650 segment. Under these circumstances, some fluctuation in RF signal power for the data communication path between satellite 200-1 and earth station 300 will occur. However, the use of an effective minimum signal-power threshold, such as one half of maximum signal power, will preferably enable the communication beam 700 between satellite 200 and earth station 300 to remain within an acceptable range.

A phased array antenna generally continuously tracks the movement of a satellite 200 by substantially continuously adjusting the orientation of a single beam to continue to point toward the satellite 200 as the satellite moves along its orbit 650. In contrast, in one or more embodiments of the present invention, as the satellite 200 moves along a segment of orbit 650, it passes through communication ranges of a plurality of separate antenna feeds 600. As satellite 200 progresses along the pertinent orbit segment, a succession of the antenna feeds is activated so as to maintain the continuity of communication between satellite 200 and earth station 300. More specifically, with reference to FIGS. 6-7, as satellite 200-1 moves along its orbit 650 (FIG. 2), satellite 200-1 communicates first with beam 700-1 provided by feed 600-1 (as reflected by sub-reflector 410 and main reflector 420). As satellite 200-1 reaches the end of the communication range for beam 700-1, feed 600-2 is preferably activated, thereby providing beam 700-2, and feed 600-1 is preferably de-activated thereby disabling beam 700-1. Thus, the communication path between satellite 200-1 and earth station 300 has been preserved by disabling beam 700-1 and enabling beam 700-2, rather than by continuously changing the orientation of any single beam.

In this embodiment, the controlled activation and de-activation of beams 700 preferably continues as satellite 200-1 proceeds along orbit 650 such that, usually, only one feed 600, of feeds 600-1 through 600-16, is powered on (activated) at any given moment. One exception to the foregoing may occur during a transition from any given feed 600-n to a next feed 600-n+1 in the sequence of feeds 600. More specifically, as satellite 200-1 transitions from beam 700-1 to beam 700-2, feed 600-1 and feed 600-2 may briefly both be activated. However, once communication is established between satellite 200-1 and feed 600-2, feed 600-1, and thus beam 700-1, may be de-activated. This process of selective activation of feeds 600 preferably continues for all feeds 600 of antenna 400 as satellite 200-1 proceeds along the pertinent segment of orbit 650.

The beam arising from each antenna feed 600 is preferably a concentrated spot beam that is configured for concentrating RF signal energy within a small, defined area with greater accuracy, and with less power, than is possible employing a traditional, phased array antenna. Moreover, the mechanism for controlling the activation of a selected one of the various feeds 600 within a given antenna 400 is relatively straightforward to implement, thereby reducing the implementation cost. Accordingly, one or more embodiments of the multiple-feed antenna disclosed herein preferably provides an inexpensive system and method for tracking a satellite 200 over a portion of orbit 650 using a less inexpensive device, capable of concentrating RF signal energy within a small footprint using a spot beam, and thereby using less power for a given amount of communication bandwidth than do existing devices.

In the above-discussed embodiments, usually only one feed is activated at a given moment. However, in alternative embodiments, the activation of a plurality of feeds 600 at one time may be practiced to enable antenna 400 to communicate with more than one satellite at a time.

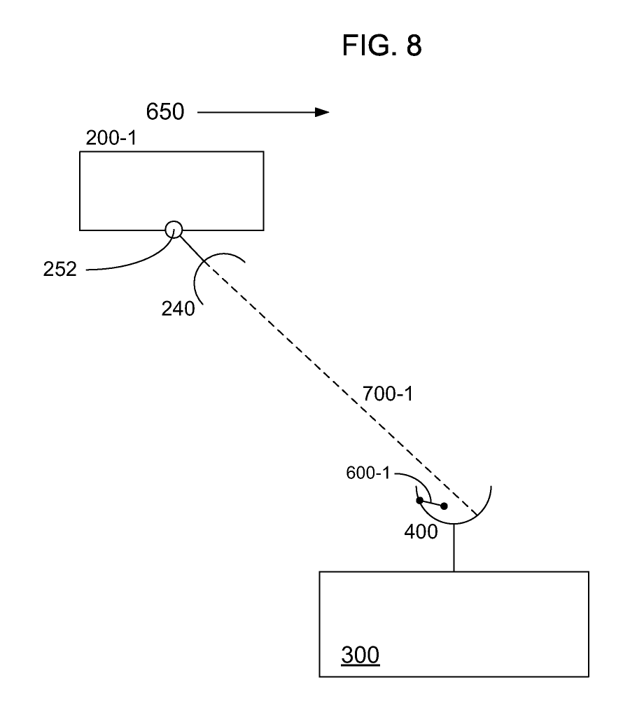

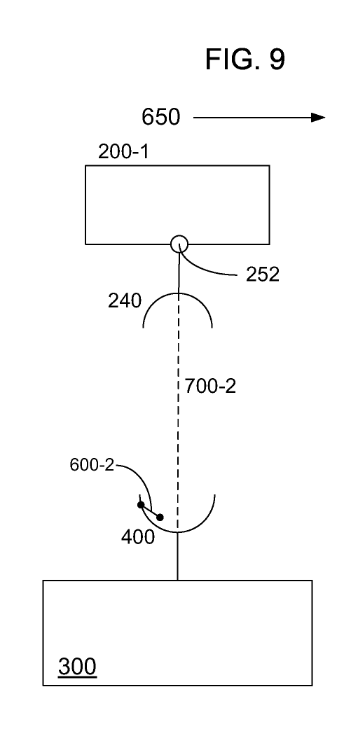

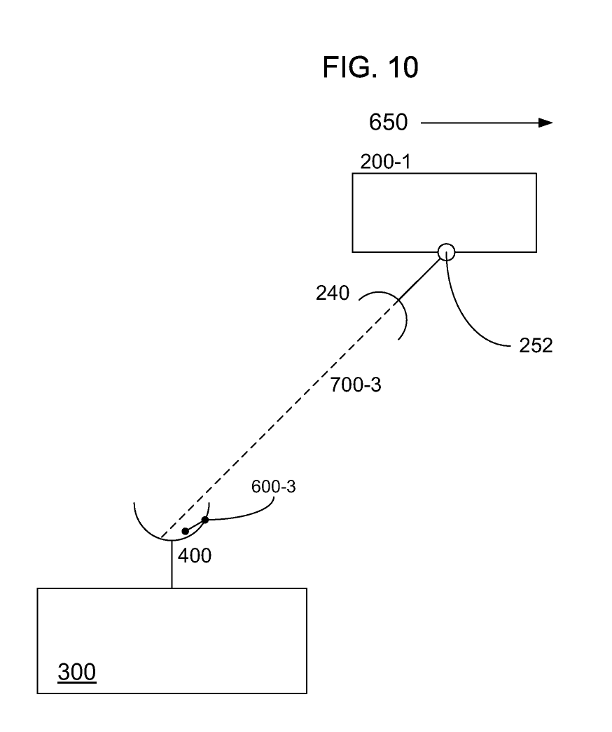

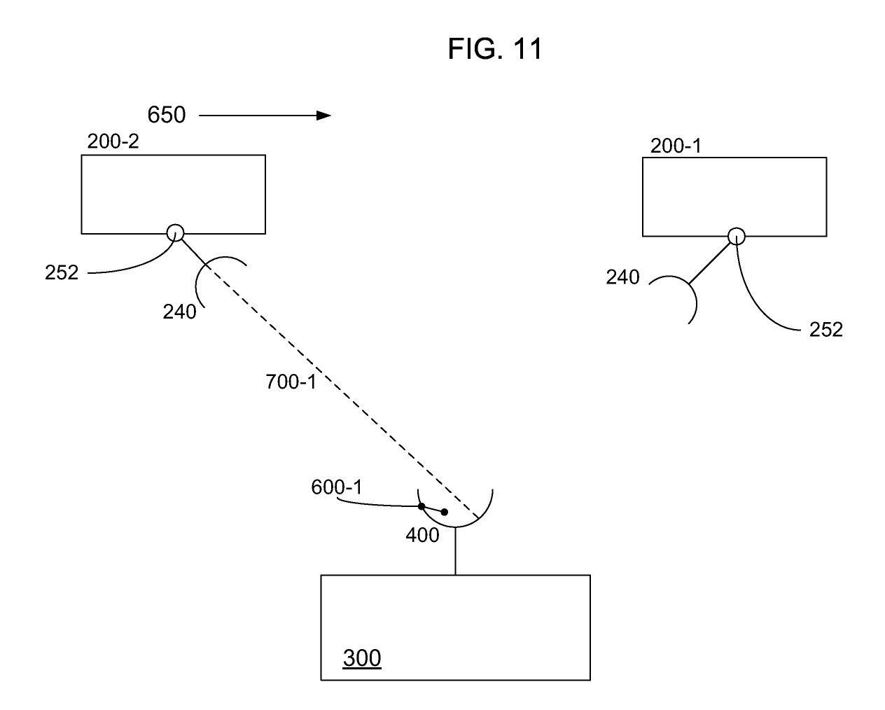

FIG. 8 is a schematic diagram of a satellite 200-1 having an antenna 240 in communication with antenna 400 at ground station 300, in accordance with an embodiment of the present invention. FIG. 9 is a schematic diagram of the system of FIG. 8 in which the satellite 200-1 has advanced along its orbit. FIG. 10 is a schematic diagram of the system of FIG. 8 in which the satellite 200-1 has advanced still further along its orbit. FIG. 11 is a schematic diagram of the system of FIGS. 8-10 in which the antenna at the earth station 300 is in communication with a second satellite, in accordance with an embodiment of the present invention. FIGS. 8-11 depict an exemplary sequence of adjustments of antenna 240 on satellite 200-1 and of antenna 400 on earth station 300 that are conducted to maintain communication between the two antennas as satellite 200-1 proceeds along orbit 650.

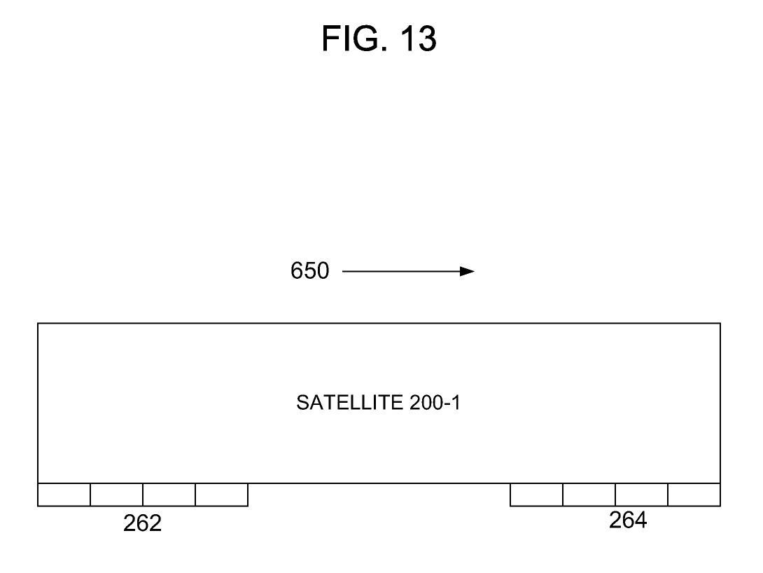

In this example, satellite 200-1 includes antenna 240 which may revolve about axis 252 to maintain its alignment with antenna 400 of earth station 300. Earth station 300 preferably includes antenna 400 which may include feeds 600-1, 600-2, and 600-3. In this embodiment, antenna 240 is a mechanically steerable antenna. However, in other embodiments, antenna 240 could be a phased array antenna (as illustrated in FIG. 13). In yet another embodiment, antenna 240 could be multiple-feed, multiple-beam antenna that conducts quasi-tracking of antenna 400 on earth station 300, and which thus operates much the way antenna 400 operates.

FIGS. 8-11 show the advancement of satellite 200-1 in relation to earth station 300 in greater detail than that provided in FIG. 2. A simplified embodiment is presented in which three feeds 600-1, 600-2, and 600-3 (collectively 600), produce three separate respective beams 700-1, 700-2, and 700-3 (collectively 700). As in earlier embodiments, usually only one of feeds 600 and a corresponding one of beams 700 is activated at any given moment. The schematic representation of feeds 600 and beams 700 has been simplified for the sake of illustration in FIGS. 8-11. Specifically, only the active feed 600-1, 600-2, or 600-3 is shown in each of FIGS. 8-11.

In FIG. 8, satellite 200-1 has reached a first stage of advancement with respect to earth station 300. At this point, feed 600-1 is activated, and antenna 400 and antenna 240 therefore communicate along beam 700-1 which is provided by feed 600-1. In this situation, feeds 600-2 and 600-3 (not shown in FIG. 8) are preferably not active (i.e. have very little or no RF signal energy directed thereto).

As satellite 200-1 proceeds from the position shown in FIG. 8 to that shown in FIG. 9, feed 600-1 and beam 700-1 are de-activated, and feed 600-2 is activated, thereby providing beam 700-2. It is noted that antenna 240 has rotated about axis 252 so as to continue to point toward antenna 400 of earth station 300. Meanwhile, antenna 400 has not moved. Instead, antenna 400 has adapted to the change in position of satellite 200-1 by transferring the data communication path from feed 600-1 and beam 700-1 resulting therefrom, to feed 600-2 and beam 700-2 resulting from feed 600-2.

As satellite 200-1 proceeds from the position shown in FIG. 2 to that shown in FIG. 3, feed 600-2 and beam 700-2 are de-activated, and feed 600-3 is activated, thereby providing beam 600-3. Once again, antenna 240 has rotated about axis 252 to maintain its alignment with antenna 400.

FIG. 11 shows satellite 200-1 leaving the communication range of earth station 300, and satellite 200-1 entering this same communication range. Thus, satellite 200-1 is no longer in communication with antenna 400. In its place, satellite 200-1 is in communication with antenna 400 along beam 700-1 provided by beam 600-1. Thus, for the simplified example of antenna 400 having three feeds 600, one full cycle of “feed switching” has been conducted, and the process is shown beginning anew with a satellite 200-2 that succeeds satellite 200-1 in satellite constellation 250. The above example indicates how antenna 400 is able to “quasi-track” the movement of satellite 200-1 by switching power through a succession of antenna feeds instead of by physically changing the orientation of any feed, beam, or reflector on antenna 400.

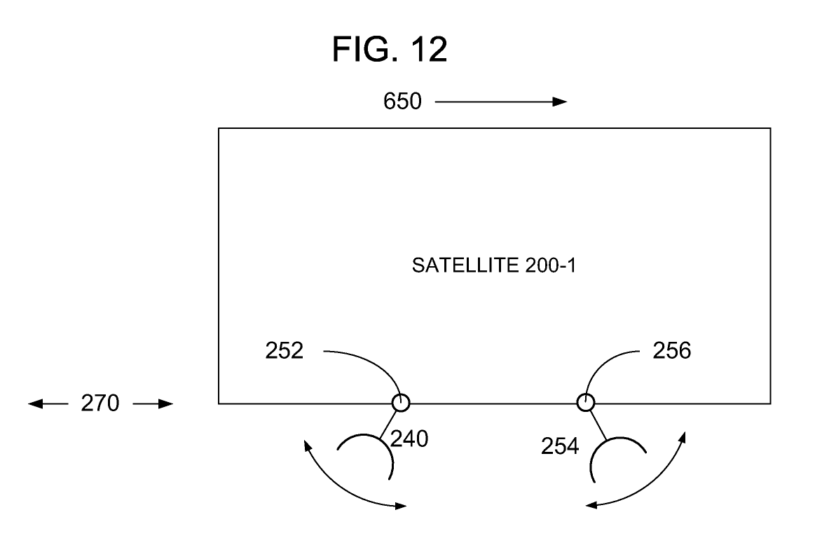

FIG. 12 is a schematic representation of satellite 200 having two mechanically steerable antennas 240, 254 in accordance with one or more embodiments of the present invention. Antenna 240 preferably rotates about axis 252, and antenna 254 preferably rotates about axis 256. Axes 252 and 256 extend into and out of the page in the view of FIG. 12. Antennas 240 and 254 may rotate about their respective axes 252 and 256 as satellite 200-1 moves along orbit 650 to maintain their respective communication paths with respective earth-based (or satellite-based) antennas with which they are communicating. Rotation about axes 252 and 256 corresponds to adjustment of the pitch angle of antennas 252 and 254, respectively. Rotation about axes 252 and 256 preferably enables satellite 200-1 to conduct communication with ground stations present over a wide range of longitude over the surface of the earth. In some embodiments, antennas 240, 254 may also rotate about axis 270 which preferably enables satellite 200-1 to communicate with ground stations 300 at a range of different latitudes on the surface of the earth. Rotation about axis 270 corresponds to adjustment of the roll axis of antennas 240, 254.

It will be appreciated that rotation about axes 252/256, and 270 does not necessarily correspond only to adjustment for longitude and latitude, respectively. In other words, in some embodiments, rotation about axis 256 by antenna 254 may change both the latitude and longitude of the location on the earth with which antenna 254 communicates. Likewise, in some embodiments, rotation of antenna 240 about axis 252 may change both the latitude and the longitude of the location on the earth with which antenna 240 communicates.

In one embodiment, antenna 240 may communicate with a ground station 300, and antenna 254 may communicate with a gateway station, thereby connecting ground station 300 to a global communication network. However, in other embodiments, this arrangement may be varied. Although only two steerable antennas 240, 254 are shown in FIG. 12, any desired number of antennas may be employed on a given satellite 200-1.

FIG. 13 is a schematic representation of a satellite 200-1 having two electronically steerable antennas 262, 264 in accordance with one or more embodiments of the present invention. In the embodiment of FIG. 13, antennas 262 and 264 may be continuously controlled to maintain respective communication paths with respective ground stations on the surface of the earth and/or with other satellites, as satellite 200-1 proceeds along its orbit 650. In one embodiment, antenna 262 may communicate with a ground station 300 on the surface of the earth, and antenna 264 may communicate with a gateway station. While two phased array antennas are shown in FIG. 13, it will be appreciated that any number of antennas could be employed. Satellite 200-1 is not limited to having just one type of antenna. Specifically, satellite 200-1 could include one or more mechanically steerable antennas and/or one or more electronically steerable antennas (such as phased array antennas).

When operating in conjunction with a suitable tracking system, antenna 262 is preferably operable to adjust the direction of a communication path along one or more angular dimensions. Specifically, antenna 262 may adjust the pitch angle and/or the roll angle (both discussed in connection with FIG. 12) of a communication beam, as needed.

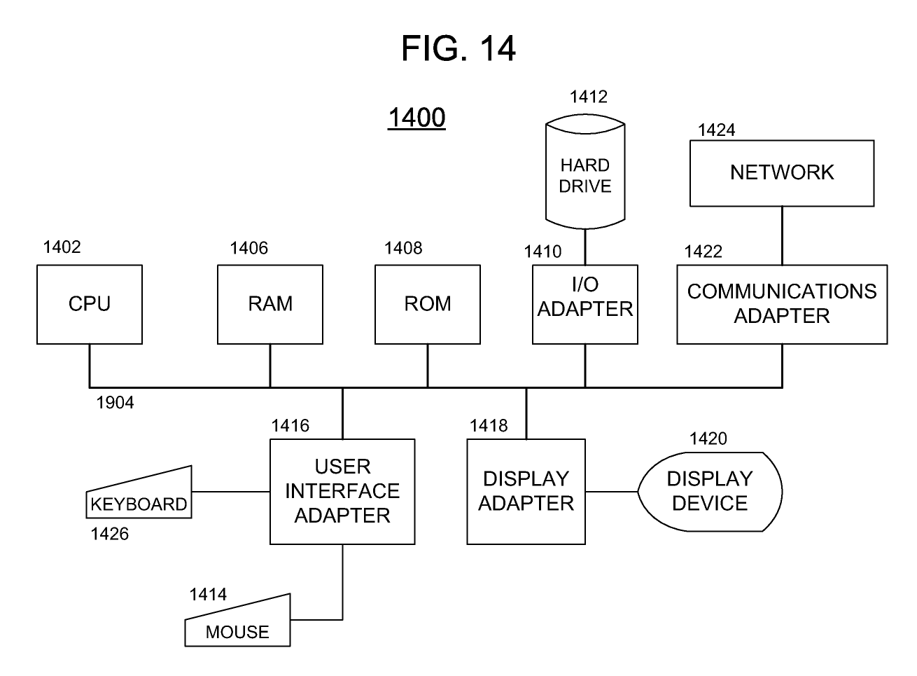

FIG. 14 is a block diagram of a computing system 1400 adaptable for use with one or more embodiments of the present invention. For example one or more portions of computing system 1400 may be employed to perform the functions of processor 314 of FIG. 3, and/or of one or more processing entities within system 100 of FIG. 1.

In one or more embodiments, central processing unit (CPU) 1402 may be coupled to bus 1404. In addition, bus 1404 may be coupled to random access memory (RAM) 1406, read only memory (ROM) 1408, input/output (I/O) adapter 1410, communications adapter 1422, user interface adapter 1406, and display adapter 1418.

In one or more embodiments, RAM 1406 and/or ROM 1408 may hold user data, system data, and/or programs. I/O adapter 1410 may connect storage devices, such as hard drive 1412, a CD-ROM (not shown), or other mass storage device to computing system 1400. Communications adapter 1422 may couple computing system 1400 to a local, wide-area, or global network 1424. User interface adapter 1416 may couple user input devices, such as keyboard 1426 and/or pointing device 1414, to computing system 1400. Moreover, display adapter 1418 may be driven by CPU 1402 to control the display on display device 1420. CPU 1402 may be any general purpose CPU.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method, comprising:
arranging a plurality of feed horns along a plurality of different respective angles about a common axis within an antenna; and
switching a communication path through the antenna through a succession of the feed horns.

2. The method of claim 1 wherein the switching step comprises:
transferring substantially an entirety of the RF (radio frequency) energy in the antenna through successive ones of the feed horns.

3. The method of claim 1 further comprising:
directing substantially all of the RF energy of the antenna through one feed horn at a time.

4. The method of claim 1 wherein each feed horn is operable, in cooperation with at least one reflector, to direct a spot beam to a satellite.

5. The method of claim 1 wherein each feed horn is configured to be able to individually handle all of the communication RF energy for the antenna.

6. An antenna, comprising:
a feed assembly including a plurality of feed horns disposed at a plurality of different respective angles within the antenna;
a detection system for tracking a movement of a satellite through a tracking range of the antenna; and
a switch for transferring a communication path through a succession of the feed horns based on data obtained by the detection system.

7. The antenna of claim 6 further comprising:
a sub-reflector operable to receive RF energy from the feed assembly; and
a main reflector for directing RF energy from the sub-reflector toward the satellite.

8. The antenna of claim 6 wherein the plurality of feed horns is operable to produce a plurality of respective communication beams oriented at a plurality of different respective topocentric beam angles.

9. The antenna of claim 6 wherein the plurality of feed horns are arranged in a row within a single plane within the feed assembly.

10. The antenna of claim 6 wherein the feed assembly is pivotable to adjust for changes in an elevation angle of the satellite as the satellite moves along its orbit.

11. A method for maintaining a communication path between an earth-based antenna and a satellite moving along an orbit, comprising:
providing a feed assembly having a plurality of feed horns oriented along a plurality of different respective angles;
determining a location along the orbit at which the satellite is located; and
activating a selected one of the feed horns that is operable to generate an RF (radio frequency) signal communication beam that enables communication between the antenna and the satellite.

12. The method of claim 11 further comprising:
not providing enough RF signal energy to enable a communication beam to feed horns other than the selected feed horn.

13. The method of claim 11 further comprising:
shifting the communication path between the antenna and the satellite through a succession of the feed horns as the satellite proceeds along the orbit.

14. The method of claim 11 wherein the determining step comprises:
measuring a level of RF signal energy received at the antenna; and
comparing the measured RF signal power level to a threshold indicative of signal power sufficiency for communication.

15. The method of claim 11 further comprising:
enabling the plurality of feed horns to generate a plurality of respective communication beams a plurality of different respective beam angles.

16. The method of claim 15 wherein the plurality of respective generated beam angles are configured to enable communication between the satellite and the antenna at a plurality of respective stages of advancement of the satellite along the orbit.

17. The method of claim 13 wherein the step of shifting the communication path comprises:
supplying RF signal energy to a selected feed horn in communication with the satellite at any given moment; and
at least substantially disabling a supply of RF signal energy to all feed horns in the feed assembly other than the selected beam.

18. The method of claim 17 wherein the steps of supplying and at least substantially disabling are performed using at least one switch.

19. The method of claim 12 further comprising:
Pivoting the feed assembly to adjust for changes in an elevation angle of the satellite as the satellite proceeds along the orbit.
